(19) United States
(12) Patent Application Publication
(10) Pub. No.: US 2007/0273894 A1
(43) Pub. Date: Nov. 29, 2007

(54) METHOD AND APPARATUS FOR REMOTE SPATIAL CALIBRATION AND IMAGING

(76) Inventors: James T. Johnson, Rigby, ID (US); Scott M. Watson, Rigby, ID (US); Dennis C. Kunerth, Idaho Falls, ID (US); Travis Brown, Chubbuck, ID (US)

Correspondence Address: BATTELLE ENERGY ALLIANCE, LLC, P.O. BOX 1625, IDAHO FALLS, ID, 83415-3899, US

(21) Appl. No.: 11/419,790

(22) Filed: May 23, 2006

(51) Int. Cl. G01B 11/14

(52) U.S. Cl. 356/625; 356/616

(57) ABSTRACT

Disclosed are remote spatial calibration apparatuses and spatial calibration methods. A first plurality of line-generating lasers is arranged for generating a first set of substantially parallel lines in a first orientation. A second plurality of line-generating lasers is arranged for generating a second set of substantially parallel lines in a second orientation. Both sets of lines are directed to project on an object and the second orientation is substantially perpendicular to the first orientation such that the lines form a matrix of lines. An imaging device is configured for obtaining an image of the object and the matrix of lines formed on the object. The spatial calibration apparatuses may be included in a housing comprising a projection face, an imaging device cavity formed in the projection face, and a plurality of laser cavities formed in the projection face.

### CONTRACTUAL ORIGIN OF THE INVENTION

The United States Government has rights in the following invention pursuant to Contract No. DE-AC07-05-ID14517 between the U.S. Department of Energy and Battelle Energy Alliance, LLC.

### BACKGROUND OF THE INVENTION

1. Field of the Invention

The present invention relates generally to spatial imaging and, more specifically, to remote spatial calibration using lasers.

2. State of the Art

For many applications, it may be necessary to determine the size and location of an object from a remote distance. For example, one application includes examining the interior of underground pipes or underground tanks for obstructions. A camera may be placed in a pipe to examine the interior of the pipe. However, due to the enclosed space and geometry of pipes, and with no frame of reference, it may be difficult to determine the location and size of an obstruction within the pipe.

Devices have been proposed to remotely determine the distance to an object. Some of these devices may use lasers to reflect a laser beam off an object and measure the phase shift of the returning reflected beam relative to the phase of the beam at the laser source. However, these systems are best used on systems for determining the profile of an object and distance to an object and may not be as useful for determining actual size of an object or features on the object. In addition, these systems may require complex electronics for measuring high frequency laser signals and the relatively small phase shift within that high frequency.

Still other proposals utilize laser line generators configured in a triangular pattern to project onto an object. The system captures an image of the triangular pattern on the object. However, while the triangular pattern may be desirable for determining distance to an object, but it may create problems for easily determining the size of the object or the location of the object. Complex mathematical analysis, such as using trigonometric functions, may be needed to measure distances from the laser-generated lines configured in a triangular pattern to determine distance from the lines to edges of the object or features on the object.

Other devices have been proposed to remotely project a cross-hair pattern comprising two perpendicular line of laser illumination on an object. These devices generally may be used for determining orientation of the device and pointing to specific locations on the object. However, measuring the size of an object based on the cross-hair pattern is problematic because, other than the thickness of the lines, there is nothing to assist in defining the scale of the object.

Therefore, there is a need for a method and apparatus for remote spatial calibration and imaging that can easily determine location and size of an object of interest as well as determine the size of features on the object by comparing the image of the object to the image of an optically generated visual pattern configured for easy orthogonal measurements.

### BRIEF SUMMARY OF THE INVENTION

The present invention provides methods and apparatuses for remote spatial calibration and imaging that can be used to easily determine location and size of an object of interest as well as determine the size of features on the object by comparing the image of the object to the image of an optically generated visual pattern configured for easy orthogonal measurements.

An embodiment of the present invention comprises a remote spatial calibration apparatus including a first plurality of line-generating lasers, a second plurality of line-generating lasers, and an imaging device. The first plurality of line-generating lasers are arranged for generating a first set of substantially parallel lines of laser illumination in a first orientation and directed to project on an object of interest. Similarly, the second plurality of line-generating lasers are arranged for generating a second set of substantially parallel lines of laser illumination in a second orientation and directed to project on the object of interest. In addition, the second orientation is substantially perpendicular to the first orientation such that the first set of substantially parallel lines and the second set of substantially parallel lines form a matrix of lines. The imaging device is configured for obtaining an image of the object of interest and the matrix of lines formed on the object of interest.

Another embodiment of the present invention comprises a spatial calibration method. The method includes generating a first set of substantially parallel lines of laser illumination in a first orientation and directed to project on an object of interest. The method further includes generating a second set of substantially parallel lines of laser illumination in a second orientation and directed to project on the object of interest. In addition, the second orientation is substantially perpendicular to the first orientation such that the first set of substantially parallel lines and the second set of substantially parallel lines form a matrix of lines. The method also includes obtaining an image of the object of interest and the matrix of lines formed on the object of interest.

Another embodiment of the present invention is a remote spatial calibration apparatus including a housing. The housing comprises a projection face, an imaging device cavity formed in the projection face, and a plurality of laser cavities formed in the projection face. The imaging device cavity is configured to receive an imaging device and direct a field of view of the imaging device in an imaging direction substantially perpendicular to the projection face. The plurality of laser cavities are configured to receive a set of line-generating lasers in an orientation to direct a set of laser lines from the set of line-generating lasers in the imaging direction.

### BRIEF DESCRIPTION OF THE DRAWINGS

In the drawings, which illustrate what is currently considered to be the best mode for carrying out the invention:

FIG. 1 is a schematic diagram of a representative embodiment of a remote spatial calibration system;

FIG. 2 is a mechanical drawing showing an end view of a representative embodiment configured as a remote spatial calibration system adaptable to imaging the interior of a pipe;

FIG. 3 is a mechanical drawing showing a cross-sectional side view of the embodiment of FIG. 2;

FIGS. 4A and 4B are photographs showing various views of the representative embodiment of FIGS. 2 and 3; and

FIGS. 5A-5D are photographs showing various views of captured images of objects of interest and a matrix of lines projected onto the object of interest and surrounding environment.

### DETAILED DESCRIPTION OF THE INVENTION

The present invention provides methods and apparatuses for remote spatial calibration and imaging that can be used to easily determine location and size of an object of interest as well as determine the size of features on the object by comparing the image of the object to the image of an optically generated visual pattern configured for easy orthogonal measurements.

In the following description, circuits and functions may be shown in block diagram form in order not to obscure the present invention in unnecessary detail. Conversely, specific circuit implementations shown and described are exemplary only and should not be construed as the only way to implement the present invention unless specified otherwise herein. Additionally, block definitions and partitioning of logic between various blocks is exemplary of a specific implementation. It will be readily apparent to one of ordinary skill in the art that the present invention may be practiced by numerous other partitioning solutions. For the most part, details concerning timing considerations and the like have been omitted where such details are not necessary to obtain a complete understanding of the present invention and are within the abilities of persons of ordinary skill in the relevant art.

In this description, some drawings may illustrate signals as a single signal for clarity of presentation and description. It will be understood by a person of ordinary skill in the art that the signal may represent a bus of signals, wherein the bus may have a variety of bit widths and the present invention may be implemented on any number of data signals including a single data signal.

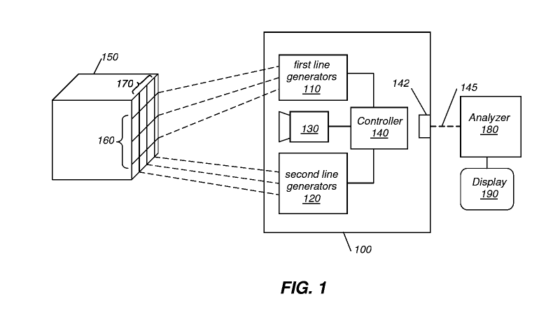

FIG. 1 is a schematic diagram of a representative embodiment of a remote spatial calibration apparatus 100 including a first set of line-generating lasers 110, a second set of line-generating lasers 120, and an imaging device 130. The remote spatial calibration system may also include a controller 140 and a communication port 142.

The first set of line-generating lasers 110 and second set of line-generating lasers 120 may be any lasers suitable for emitting laser light in the shape of a line substantially perpendicular to the direction of the projection of light. The line may be generated using a number of techniques, such as, for example, cylindrical lenses, sweeping lasers, holographic lenses, masks, and the like.

The first set of line-generating lasers 110 are configured and aligned to generate a first set of substantially parallel lines 160 of laser illumination in a first orientation. In FIG. 1, the first orientation is illustrated as substantially horizontal. Similarly, the second set of line-generating lasers 120 are configured and aligned to generate a second set of substantially parallel lines 170 of laser illumination in a second orientation. In FIG. 1, the second orientation is illustrated as substantially vertical. Thus, to generate a matrix of lines wherein the first set of substantially parallel lines 160 and the second set of substantially parallel lines 170 are perpendicular to each other, the second orientation is defined as perpendicular to the first orientation. For convenience in description, the first orientation may be referred to as horizontal and the second orientation may be referred to as vertical. However, any orientation is contemplated within the scope of the present invention, limited only by the second orientation being substantially perpendicular to the first orientation.

The remote spatial calibration apparatus 100 may be directed at an object of interest 150 (also referred to as a target) such that the first set of substantially parallel lines 160 and the second set of substantially parallel lines 170 form the matrix of lines on the object of interest 150.

Each set of line-generating lasers includes at least two lasers and may include many more lasers for generating a varying granularity of lines in the matrix of lines, and generating different sizes for the matrix of lines, as is explained below. For the representative embodiment illustrated in FIG. 1, the first set of line-generating lasers 110 and the second set of line-generating lasers 120 each comprise three line-generating lasers.

Each of the line-generating lasers, may include an orientation mechanism (not shown) to individually orient each of the lines relative to other lines in either a substantially parallel arrangement, a substantially perpendicular arrangement, or combinations thereof. With the orientation mechanism, fine-tuning for alignment of the lines may be performed, and each of the line-generating lasers may be configured to be in the first set 110, or the second set 120 of line-generating lasers. Each of the line-generating lasers, may also include a focusing mechanism (not shown) to individually focus each of the laser lines. Thus, for producing a sharp, clear matrix of lines, the laser lines may be focused at a focal depth that substantially matches the focal depth of the imaging device 130.

The imaging device 130 may be configured in the remote spatial calibration apparatus 100 such that it is directed in substantially the same direction as the line-generating lasers. Thus, the imaging device 130 can capture an image of the object of interest 150 and the matrix of lines projected onto the object of interest 150. The imaging device 130 may be any device suitable device for capturing images, such as, for example, a video camera, a still camera, a digital camera, a Complementary Metal Oxide Semiconductor (CMOS) imaging device 130, a charge coupled device (CCD) imager, and the like. In addition, the imaging device 130 may include optical devices for modifying the image to be captured, such as, for example, lenses, collimators, filters, and mirrors.

The remote spatial calibration apparatus 100 may include a controller 140 operably coupled to the first set of line-generating lasers 110, the second set of line-generating lasers 120, and the imaging device 130. The controller 140 may be relatively simple. For example, and not limitation, the controller 140 may only control simple functions such as enabling the line-generating lasers (110 and 120), enabling the imaging device 130, and controlling when to capture images. However, the controller 140 may be much more complex, performing functions such as orienting the line-generating lasers (110 and 120) and imaging device 130, focusing the line-generating lasers (110 and 120) and imaging device 130, and processing the captured images. As an example, and not limitation, the controller 140 may be configured to compress the image data such that less data needs to be communicated out of the remote spatial calibration apparatus 100.

As another example, the controller 140 may be configured to enable some of the line-generating lasers (110 and 120) and disable others of the line-generating lasers (110 and 120) to generate a different size matrix or modify the granularity of lines in the matrix. As an example of a larger matrix, in some applications the overall assembly may tilt such that the imaging device 130 is not pointed directly at the target. In this case, a larger matrix of lines may be useful to ensure coverage of the target by at least some of the lines in the larger matrix.

Some embodiments of the remote spatial calibration apparatus 100 may be configured without a controller (not shown). In those embodiments, if there is any control needed for the line-generating lasers (110 and 120) and the imaging device 130, the control may be performed through a communication port 142 directly connected to the line-generating lasers (110 and 120) and imaging device 130. For example, and not limitation, the only control required may be simply to determine when to capture images.

The remote spatial calibration apparatus 100 may include a communication port 142 operably coupled to the controller 140 or directly to the line-generating lasers (110 and 120) and imaging device 130. The communication port 142 may be configured for communication across a communication channel 145 to an analyzer 180. The communication port 142 should be suitable for transferring images from the imaging device 130 at a resolution (and frame rate if video is used) adequate for performing spatial analysis on the transferred images. In addition, for flexibility of supporting multiple application environments, the communication channel 145 may be adaptable to both wired and wireless communication, as well as supporting various communication channels 145. By way of example, and not limitation, the communication port 142 may be configured as a serial or parallel communication channel, such as, for example, USB, IEEE-1394, 802.11 a/b/g, and other wired and wireless communication protocols.

In some embodiments, the analyzer 180 may be used for automatically performing spatial analysis and measurements of the target. In other embodiments, an analyzer 180 may not be necessary and the user may perform measurements directly from the captured image. Images that have been acquired with no spatial reference cannot be considered quantitative data since there is no means of obtaining a pixel versus physical dimension correlation. The line-generating lasers (110 and 120) produced a fiduciary matrix on the target, thereby creating reference points that may be used to obtain a calibrated spatial map over the entire image. These reference points remain relatively constant regardless of the camera type, aspect ratio, lens configuration, focal length or magnification, provided the region of interest is in the focal range of the imaging device 130. With the matrix of lines projected on the target, the analyzer 180 may use image processing to analyze the image by converting the fiduciary matrix into an overall spatial map of the image, wherein actual distances between reference points may be correlated to a specific number of pixels in the image.

The analyzer 180 may include dedicated hardware for performing the image analysis or may be a general-purpose computer executing image processing software to perform the analysis. In addition, the analyzer 180 may include a display 190 for displaying the captured image and other data, such as, for example, the target size, target position, and ratio of number of pixels to separation distance between neighboring lines.

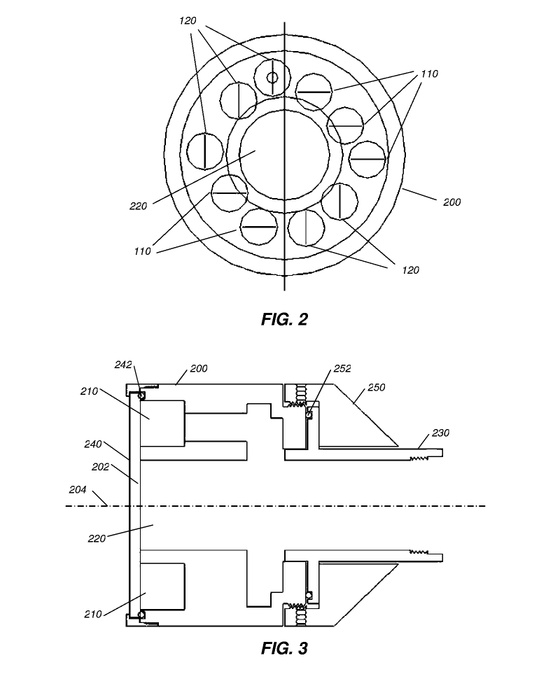

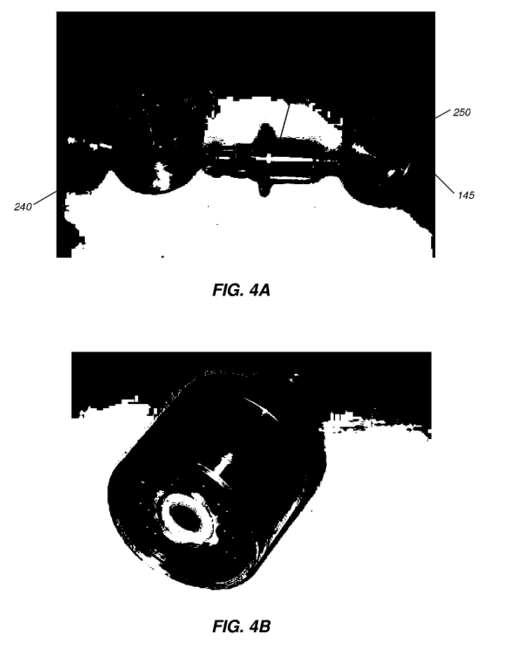

FIG. 2 is a mechanical drawing showing an end view of a representative embodiment configured as a remote spatial calibration system adaptable to imaging the interior of a pipe. FIG. 3 is a mechanical drawing showing a cross-sectional side view of the embodiment of FIG. 2. The embodiment of FIGS. 2 and 3 includes a housing 200, an end cap 240, an imaging device casing 230, and a back cap 250. The housing 200 includes a projection face 202, laser cavities 210 formed from the projection face 202 into the housing 200 for accepting the line-generating lasers (110 and 120) and an imaging device cavity 220 formed from the projection face 202 into the housing 200. The laser cavities 210 are formed such that the line-generating lasers (110 and 120) project the lines in a direction substantially perpendicular to the projection face 202. Similarly, the imaging device cavity 220 is formed such the imaging device 130 is oriented in a direction substantially perpendicular to the projection face 202 and substantially parallel with a longitudinal axis 204 of the housing 200.

As illustrated in FIG. 2, ten line-generating lasers (110 and 120) may be place in the housing 200, such that five of the line-generating lasers (110 and 120) form horizontal lines, and five of the line-generating lasers (110 and 120) form vertical lines. These orientations may be changed such that the matrix may comprise a different number of lines in the horizontal and vertical orientations. For example, and not limitation, a target may be shaped such that a 3×7 matrix of lines may be more useful than a 5×5 matrix of lines.

The representative embodiment of FIGS. 2 and 3 includes the imaging device casing 230 for holding the imaging device 130. In addition, the end cap 240 may be used to protect the imaging device 130 and line-generating lasers (110 and 120). The back cap 250 attaches to the back end of the housing 200 in a manner that secures the imaging device casing 230 in place in the imaging device cavity 220. The overall assembly may include an end cap sealing ring 242, and a back sealing ring 252 such that the final assembly generates a substantially water-tight seal and protects the imaging device 130 and the set of line-generating lasers (110 and 120) from damaging elements.

In FIG. 3, the end cap 240 and back cap 250 are shown with an attachment mechanism of a threaded connection. However, any suitable secure connection may be used, such as, for example, a secure press-fit, a threaded connection, an epoxy connection, and a welded connection.

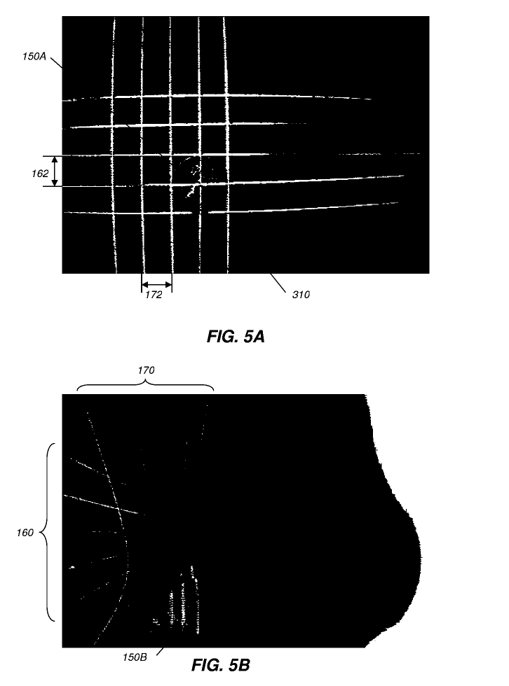

FIGS. 4A-4B are photographs showing various views of the representative embodiment of FIGS. 2 and 3. FIG. 4A is an unassembled view showing the separate housing 200, end cap 240, back cap 250, imaging device casing 230 holding the imaging device 130, and communication channel 145. Note in this embodiment, the imaging device 130 may be removed from the housing 200 for use in other systems. FIG. 4B is an assembled view of the remote spatial calibration apparatus 100.

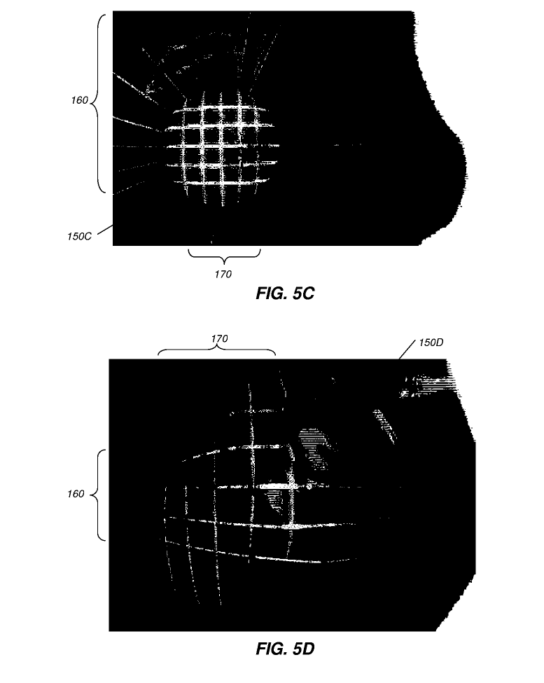

FIGS. 5A-5D are photographs showing various views of captured images of objects of interest and a matrix of lines projected onto the object of interest 150 and surrounding environment. FIG. 5A shows a penny 150A imaged on a flat surface, wherein the flat surface includes a background grid 310 with horizontal and vertical lines at a spacing of 0.375 inches. The optical distortion is due to the imaging device lens. The lens in this representative embodiment has a 3.6 mm focal length with a field of view of 70 degrees, making it a “fisheye” style lens. However, even with the distortion created by this fisheye lens, all measurements made with this lens were still within 5% of the actual size of the target. Applications and systems wherein a fisheye lens is not needed may be even more accurate.

A background grid 310 in FIG. 5A was useful for calibrating a first separation distance 162 between neighboring lines in the horizontal direction and a second separation distance 172 between neighboring lines in the vertical directions. With the background grid 310 substantially matching the matrix of lines generated by the lasers, the separation distance (162 and 172) may be easily determined to be about 0.375 inches, or about 50 pixels on the image. Thus, the penny target 150A had a target size of 101 pixels, which may be correlated to a size of about 0.75 inches.

FIG. 5B is an image of the matrix of lines (160 and 170) along with a golf ball 150B with a tennis ball in the background, both of which are inside a 5½″ aluminum pipe. In this image, the separation distance for the neighboring lines is about 0.375 inches, which corresponds to about 24 pixels. Thus, the golf ball target 150B can be measured as about 107 pixels, or about 1.67 inches.

FIG. 5C is an image of the matrix of lines (160 and 170) and a tennis ball 150C inside a 4″ black PVC pipe. In this image, the separation distance 162 for the neighboring lines is about 0.375 inches, which corresponds to about 33 pixels. Thus, the tennis ball target 150C can be measured as about 210 pixels, or about 2.38 inches.

FIG. 5D is an image of the matrix of lines (160 and 170) and an aluminum soda can 150D inside a 5½″ aluminum pipe. In this image, the separation distance for the neighboring lines is about 0.375 inches, which corresponds to about 60 pixels. Thus, the soda can target 150D, in one of the dimensions, can be measured as about 382 pixels, or about 2.39 inches.

Although this invention has been described with reference to particular embodiments, the invention is not limited to these described embodiments. Rather, the invention is limited only by the appended claims, which include within their scope all equivalent devices or methods that operate according to the principles of the invention as described.

What is claimed is:

1. A remote spatial calibration apparatus, comprising:
a first plurality of line-generating lasers arranged for generating a first set of substantially parallel lines of laser illumination in a first orientation and directed to project on an object of interest;
a second plurality of line-generating lasers arranged for generating a second set of substantially parallel lines of laser illumination in a second orientation and directed to project on the object of interest, wherein the second orientation is substantially perpendicular to the first orientation, to form a matrix of lines; and
an imaging device configured for obtaining an image of the object of interest and the matrix of lines formed on the object of interest.

2. The apparatus of claim 1, wherein the first plurality of line-generating lasers and the second plurality of line-generating lasers each comprise five line-generating lasers.

3. The apparatus of claim 1, wherein each of the first plurality of line-generating lasers include an orientation mechanism for adjusting its orientation to substantially parallel to another of the first plurality of line-generating lasers, substantially perpendicular to at least one of the second plurality of line-generating lasers, and combinations thereof.

4. The apparatus of claim 1, wherein each of the second plurality of line-generating lasers include an orientation mechanism for adjusting its orientation to substantially parallel to another of the second plurality of line-generating lasers, substantially perpendicular to at least one of the first plurality of line-generating lasers, and combinations thereof.

5. The apparatus of claim 1, wherein each of the first plurality of line-generating lasers and each of the second plurality of line-generating lasers include a focusing mechanism to enable focusing the matrix of lines to substantially near a focal depth of the imaging device.

6. The apparatus of claim 1, further comprising a controller operably coupled to the first plurality of line-generating lasers, the second plurality of line-generating lasers, and the imaging device, wherein the controller is configured to enable all of the line-generating lasers, enable the imaging device, and control obtaining the image of the object of interest and the matrix of lines formed on the object of interest.

7. The apparatus of claim 6, wherein the controller further comprises a communication port configured for communication with an analyzer and wherein the analyzer is configured for receiving the image obtained by the imaging device and for determining a two-dimensional size of the object of interest by comparing the image of the object of interest to a separation distance between neighboring lines of the matrix of lines.

8. The apparatus of claim 7, wherein the two-dimensional size is determined by determining a first number of pixels of the image between the neighboring lines in the first set of substantially parallel lines and determining a second number of pixels of the image between the neighboring lines in the second set of substantially parallel lines.

9. The apparatus of claim 7, wherein the analyzer further comprises a display for displaying the image of the object of interest and the matrix of lines formed on the object of interest.

10. The apparatus of claim 7, wherein the communication port is configured for a communication mode selected from the group consisting of direct wired communication, wireless communication, and combinations thereof.

11. A spatial calibration method, comprising:
generating a first set of substantially parallel lines of laser illumination in a first orientation and directed to project on an object of interest;
generating a second set of substantially parallel lines of laser illumination in a second orientation and directed to project on the object of interest, wherein the second orientation is substantially perpendicular to the first orientation, to form a matrix of lines;
obtaining an image of the object of interest and the matrix of lines formed on the object of interest.

12. The apparatus of claim 11, wherein the first set of substantially parallel lines and the second set of substantially parallel lines each comprise five lines.

13. The apparatus of claim 11, further comprising adjusting an orientation of at least one of the first set of substantially parallel lines to be substantially parallel to another of the first set of substantially parallel lines, substantially perpendicular to at least one of the second set of substantially parallel lines, and combinations thereof.

14. The apparatus of claim 11, further comprising adjusting an orientation of at least one of the second set of substantially parallel lines to be substantially parallel to another of the second set of substantially parallel lines, substantially perpendicular to at least one of the first set of substantially parallel lines, and combinations thereof.

15. The apparatus of claim 11, further comprising focusing the matrix of lines to substantially near a focal depth of the object of interest.

16. The method of claim 11, further comprising:
enabling the act of generating the first set of substantially parallel lines;
enabling the act of generating the second set of substantially parallel lines;
enabling the act of obtaining the image; and
controlling when to obtain the image.

17. The method of claim 16, further comprising:
communicating the image to an analyzer;
determining, on the analyzer, a two-dimensional size of the object of interest by comparing the image of the object of interest to a separation distance between neighboring lines of the matrix of lines.

18. The method of claim 17, wherein the two-dimensional size is determined by determining a first number of pixels of the image between the neighboring lines in the first set of substantially parallel lines and determining a second number of pixels of the image between the neighboring lines in the second set of substantially parallel lines.

19. The method of claim 17, further comprising displaying, on a display, the image of the object of interest and the matrix of lines formed on the object of interest.

20. The method of claim 17, wherein communicating the image includes a process selected from the group consisting of direct wired communication, wireless communication, and combinations thereof.

21. A remote spatial calibration apparatus, comprising:
a housing comprising:
a projection face;
an imaging device cavity formed in the projection face, the imaging device cavity configured to receive an imaging device and direct a field of view of the imaging device in an imaging direction substantially perpendicular to the projection face; and
a plurality of laser cavities formed in the projection face, the plurality of laser cavities configured to receive a set of line-generating lasers in an orientation to direct a set of laser lines from the set of line-generating lasers in the imaging direction.

22. The apparatus of claim 21, further comprising:
a first plurality of line-generating lasers disposed in a portion of the plurality of laser cavities and arranged for generating a first set of substantially parallel lines of laser illumination in a first orientation and directed to project on an object of interest;
a second plurality of line-generating lasers disposed in another portion of the plurality of laser cavities and arranged for generating a second set of substantially parallel lines of laser illumination in a second orientation and directed to project on the object of interest, wherein the second orientation is substantially perpendicular to the first orientation, to form a matrix of lines.

23. The apparatus of claim 22, further comprising:
the imaging device disposed in the imaging device cavity and configured for obtaining an image of the object of interest and the matrix of lines formed on the object of interest.

24. The apparatus of claim 21, wherein the housing is substantially cylindrical, the projection face comprises one end of the cylinder, and the imaging direction is oriented substantially parallel to a longitudinal axis of the cylindrical housing.

25. The apparatus of claim 24, further comprising an end cap configured for attachment to the projection face, wherein the end cap is substantially transparent in the vicinity of the imaging device cavity and the plurality of laser cavities.

26. The apparatus of claim 25, further comprising a back cap configured for attachment to a back end of the cylinder opposite the projection face.

27. The apparatus of claim 26, wherein the end cap and the back cap are attached to the housing with a connection selected from the group consisting of a secure press-fit, a threaded connection, an epoxy connection, and a welded connection.

28. The apparatus of claim 26, wherein the end cap and the back cap each further comprise a sealing ring configured to generate a substantially water-tight seal and protect the imaging device and the set of line-generating lasers from damaging elements.
